(19) United States
(12) Patent Application Publication
(10) Pub. No.: US 2025/0030264 A1
(43) Pub. Date: Jan. 23, 2025

(54) METHOD FOR CHARGING AND OPERATING A BATTERY, DEVICE, AND USE THEREOF

(71) Applicant: Robert Bosch GmbH, Stuttgart (DE)

(72) Inventors: Moritz Braeuchle, Walddorfhaeslach (DE); Henrick Brandes, Ludwigsburg (DE); Ian Faye, Stuttgart (DE)

(21) Appl. No.: 18/714,341

(22) PCT Filed: Dec. 12, 2022
(86) PCT No.: PCT/EP2022/085445

§ 371 Date: May 29, 2024

(30) Foreign Application Priority Data
Dec. 16, 2021 (DE) 10 2021 214 485.3

(51) Int. Cl. H02J 7/00; B60L 58/26

(52) U.S. Cl. CPC H02J 7/007194; H02J 7/0047; B60L 58/26

(57) ABSTRACT

A method for charging and operating a battery. The battery is charged in a charging process. It is provided that a maximum permissible predictive charging temperature of the battery during the charging process is specified depending on a specifiable operating state of the battery subsequent to the charging process, such that the maximum operating temperature of the battery during the operating state is less than or equal to a maximum permissible operating temperature of the battery.

### FIELD

The present invention relates to a method for charging and operating a battery, to a device for carrying out a method for charging and operating a battery, and to a use of such a device.

### BACKGROUND INFORMATION

In order to implement electromobility, rechargeable batteries are used to repeatedly convert chemical energy into electrical energy. Lithium-ion batteries are particularly suitable for this purpose due to their comparatively low self-discharge and relatively high energy density. Such a lithium-ion battery typically has a plurality of battery modules, which in turn contain a plurality of battery cells.

German Patent No. DE 10 2017 210 303 B3 describes a method for operating a battery in a motor vehicle, wherein, in the charging operating state thereof, the battery is charged by means of a rapid charging device. The process is terminated when a maximum permissible charging temperature is reached.

### SUMMARY

According to the present invention, a method for charging and operating a battery, a device for carrying out a method for charging and operating a battery, and a use of such a device are provided.

In the method according to an example embodiment of the present invention, the battery is charged in a charging process, wherein a maximum permissible predictive charging temperature of the battery during the charging process is specified depending on a specifiable operating state of the battery subsequent to the charging process, such that the maximum operating temperature of the battery during the subsequent specifiable operating state is less than or equal to a maximum permissible operating temperature of the battery.

If a battery, which is, for example, used in an electric vehicle, is charged, for example at a charging column at a highway, and it is foreseeable that the trip of the electric vehicle subsequent to the charging process will continue at a high load and/or speed and associated high thermal losses, the cooling power of the electric vehicle is not sufficient in many cases, for example if the vehicle cabin must additionally be air-conditioned, to dissipate the thermal losses that occur increasingly due to the high load and/or speed. The result is that the electric vehicle is regulated down for thermal reasons. The method according to the present invention is to prevent this by adjusting the maximum permissible charging temperature, taking into account the predicted subsequent driving and load profile.

Further advantageous embodiments of the present invention are disclosed herein.

For example, according to an example embodiment of the present invention, it is advantageous if the maximum permissible charging temperature of the battery is not exceeded at the end of the charging process.

During the charging process, the temperature of the battery increases due to thermal losses resulting from the internal resistance of the battery and especially at higher charging power. The temperature increase of the battery is permitted up to the maximum permissible operating temperature of the battery until the higher charging power is then regulated down in order to prevent the maximum permissible operating temperature from being exceeded. The down-regulation of the higher charging power and the associated reduction of the thermal losses becomes necessary since the performance of a cooling system provided for the battery reaches its limits, in particular, for example, when taking into account other drive components of an electric vehicle, and sufficient heat can no longer be dissipated from the battery.

The temperature of the battery is then approximately maintained at most at this maximum permissible operating temperature until the end of the charging process. At the end of the charging process, the temperature of the battery then remains below or at the maximum permissible operating temperature. At this temperature level, an operating process of the battery, for example in the form of a subsequent trip of the electric vehicle, is then started. As a result of the relatively high battery temperature, the output power is then limited, for example during the continuation of the trip, in order not to exceed the maximum permissible operating temperature during the trip as well. This limitation of the output power is necessary since drawing energy from the battery would also cause losses in the battery and would further heat the battery.

In the case of a higher load, e.g., due to higher speeds, inclines, trailer operation, or high outside temperatures, the problem often occurs that the performance of the cooling system is no longer sufficient to dissipate long-term and permanent power losses, in particular in combination with further cooling requirements, for example of the vehicle cabin or of the occupants. In the cases mentioned above, only a limited power of the battery is thus available after the charging process and represents a noticeable limitation of the performance of the electric vehicle for the driver. This may even become relevant to safety, for example when overtaking. In order to counteract this situation, the entire cooling system can be adjusted and enlarged, which is associated with significant costs and results in a significant change to the air heat exchangers and air inlets or additional measures on the charging infrastructure side. Vehicle-side measures, in turn, have a significant influence on the design of the vehicle front. These major changes can be avoided with the method according to the present invention in that the maximum permissible charging temperature of the battery is not exceeded at the end of the charging process and the situation of limited performance of the battery is avoided as much as possible.

According to an example embodiment of the present invention, it is also advantageous if the maximum permissible charging temperature of the battery is determined depending on at least one health state of the battery. Alternatively or additionally, it is advantageous if the maximum permissible charging temperature of the battery is determined depending on a state of charge of the battery.

Furthermore, according to an example embodiment of the present invention, it is advantageous if the maximum permissible charging temperature of the battery is determined taking into account at least one charging power present during the charging process. Alternatively or additionally, it is advantageous if the maximum permissible charging temperature of the battery is determined taking into account at least one expected charging power or one expected charging power curve during the charging process. In addition, it is advantageous if the maximum permissible charging temperature of the battery is determined taking into account a present heat development in the battery in the operating state. Alternatively or additionally, it is advantageous if the maximum permissible charging temperature of the battery is determined taking into account an expected heat development in the battery in the operating state.

According to an example embodiment of the present invention, it is furthermore advantageous if the battery is cooled in the operating state by means of a cooling device, wherein the maximum permissible charging temperature of the battery is determined taking into account a present maximum available cooling power of the cooling device. Alternatively or additionally, it is advantageous if the battery is cooled in the operating state by means of the cooling device, wherein the maximum permissible charging temperature of the battery is determined taking into account an expected maximum available cooling power of the cooling device.

These measures offer the advantage that a temperature reserve is held available in the battery at the end of the charging process, so that, in the subsequent operating state of the battery, the maximum permissible operating temperature of the battery is unlikely to be exceeded due to the heavy load. This takes place taking into account the maximum available cooling power, the expected charging power curve and the expected heat development of the battery, taking into account all further heat sources of the vehicle that need to be cooled. This ensures the desired performance of the battery after the charging process.

According to a further aspect of the present invention, a device for carrying out a method for charging and operating a battery is provided.

The device according to an example embodiment of the present invention comprises a control unit for controlling a charging process of the battery, and a simulation unit. According to the present invention, it is provided that the simulation unit is designed to ascertain a maximum permissible charging temperature of the battery during the charging process depending on a specifiable operating state of the battery subsequent to the charging process.

It is thus advantageous if the simulation unit is furthermore designed to ascertain the maximum permissible charging temperature of the battery taking into account a present heat development in the battery in the operating state. Alternatively or additionally, it is advantageous if the simulation unit is furthermore designed to ascertain the maximum permissible charging temperature of the battery taking into account an expected heat development in the battery in the operating state.

The device according to the present invention is used in an at least partially electrically driven vehicle.

### BRIEF DESCRIPTION OF THE DRAWINGS

Advantageous embodiments of the present invention are illustrated in the figures and explained in more detail in the following description of the figures.

FIG. 1 shows an exemplary curve of a charging and operating temperature in a method for charging and operating a battery according to an example embodiment of the present invention.

FIG. 2 is a sectional view of a device for carrying out a method for charging and operating a battery according to an example embodiment of the present invention.

### DETAILED DESCRIPTION OF EXAMPLE EMBODIMENTS

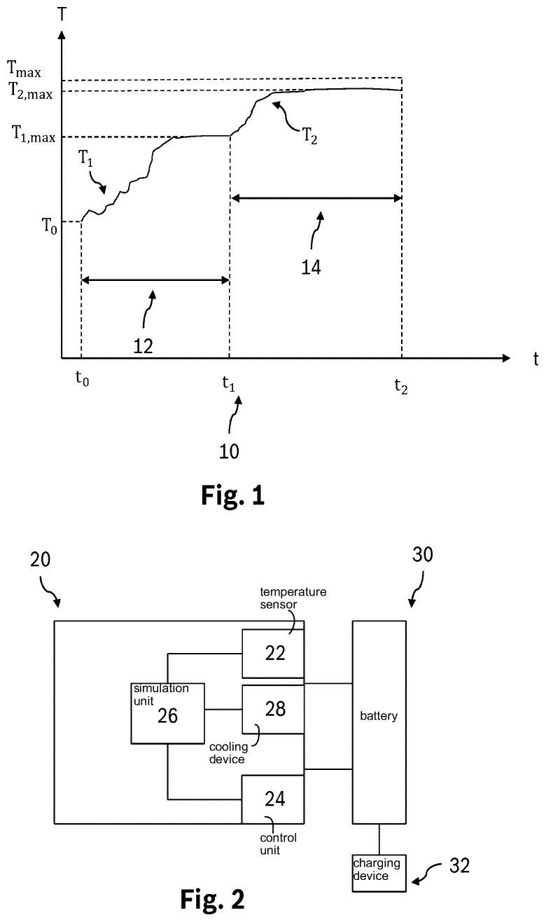

FIG. 1 shows an exemplary curve 10 of a charging and operating temperature T₁, T₂ over time t in a method for charging and operating a battery according to an example embodiment of the present invention.

At a start time t₀ of a charging process 12, the battery is prepared for a charging process 12 by reducing the temperature of the battery, for example to an initial charging temperature T₀. The charging process 12 is carried out, for example, by means of a rapid charging device. During the charging process 12, the charging temperature T₁ increases, for example due to thermal losses in the battery at a higher charging power. The temperature increase is permitted up to a maximum permissible predictive charging temperature T_{1,max} of the battery. The maximum permissible predictive charging temperature T_{1,max} of the battery is reached at the end of the charging process 12 at a first time t₁, for example. This maximum permissible charging temperature T_{1,max} is thus considered as the target value for the charging process 12.

From the first time t₁, the battery is in an operating state 14. In this operating state 14 until a second time t₂, the battery is used, for example, to drive an electric machine in an electric vehicle. The operating temperature T₂ of the battery in the operating state 14 increases, for example, up to a maximum operating temperature T_{2,max}. The temperature increases here, for example, due to thermal losses resulting from an internal resistance of the battery. The maximum operating temperature T_{2,max} is, for example, lower than the maximum permissible operating temperature Tₘₐₓ of the battery. The maximum permissible operating temperature Tₘₐₓ of the battery depends, for example, on a health state of the battery.

FIG. 2 schematically shows a sectional view of a device 20 for carrying out a method for charging and operating a battery 30 having a curve 10 of a charging and operating temperature T₁, T₂ over time t according to FIG. 1.

The device 20 is, for example, electronically coupled to the battery 30, which is charged, for example, by means of a charging device 32. The charging device 32 may, for example, be a charging column on a highway.

The device 20 comprises, for example, at least one temperature sensor 22 for detecting at least one temperature of the battery 30 that is present in real time. This at least one present temperature may, for example, be a representative charging temperature T₁ of the battery 30 during the charging process 12 or the operating temperature T₂ of the battery 30 in the operating state 14.

The device 20 also comprises a control unit 24, which serves to start the charging process 12 of the battery 30 and to specify the duration and the course of the charging process 12 of the battery 30. The control unit 24 is, for example, electronically coupled to a simulation unit 26, which is provided in a preferably central control device of a vehicle so that more direct processing of information, such as cooling requirement and cooling capability, external conditions, predicted driving or load profile of the vehicle, can be performed. The simulation unit 26 serves to ascertain the maximum permissible predictive charging temperature T_{1,max} of the battery 30 during the charging process 12, taking into account, for example, a loss characteristic map of the battery 30 in the operating state 14. Furthermore, the simulation unit 26 serves to specify the maximum permissible charging temperature T_{1,max} as a target value for the charging process 12 of the battery 30. The operating state 14 of the battery 30 takes place, for example, after the charging process 12 of the battery 30.

Furthermore, the device 20 comprises a cooling device 28, which is, for example, electronically coupled to the simulation unit 26 and which serves to cool the battery 30 by means of a coolant, such as water, and thus to reduce the temperature of the battery 30 at the start time t₀ of the charging process 12 to the initial charging temperature T₀.

The device 20 is, for example, used in an at least partially electrically driven vehicle, such as an electric vehicle (EV), a hybrid vehicle (HEV) or a plug-in hybrid vehicle (PHEV).

1-8. (canceled)

9. A method for charging and operating a battery, the method comprising:
charging the battery in a charging process, a maximum permissible predictive charging temperature of the battery during the charging process being specified depending on a specifiable operating state of the battery subsequent to the charging process, such that a maximum operating temperature of the battery during the subsequent specifiable operating state is less than or equal to a maximum permissible operating temperature of the battery.

10. The method according to claim 9, wherein the maximum permissible predictive charging temperature of the battery is not exceeded at an end of the charging process.

11. The method according to claim 9, wherein the maximum permissible predictive charging temperature of the battery is determined depending on at least one health state and/or one state of charge of the battery.

12. The method according to claim 9, wherein the maximum permissible predictive charging temperature of the battery is determined taking into account at least one present and/or expected charging power during the charging process and one present and/or expected heat development in the battery in the operating state.

13. The method according to claim 9, wherein the battery is cooled in the operating state using a cooling device, wherein the maximum permissible predictive charging temperature of the battery is determined taking into account a present and/or expected maximum available cooling power of the cooling device.

14. A device configured to for charge and operate a battery, comprising:
a control unit configured to control a charging process of the battery; and
a simulation unit configured to ascertain a maximum permissible predictive charging temperature of the battery during the charging process depending on a specifiable operating state of the battery subsequent to the charging process;
wherein the device is configured to charge the battery in the charging process, the maximum permissible predictive charging temperature of the battery during the charging process being specified depending on the specifiable operating state of the battery subsequent to the charging process, such that a maximum operating temperature of the battery during the subsequent specifiable operating state is less than or equal to a maximum permissible operating temperature of the battery.

15. The device according to claim 14, wherein the simulation unit is further configured to ascertain the maximum permissible predictive charging temperature of the battery taking into account a present and/or expected heat development in the battery in the operating state.

16. The device according to claim 14, wherein the device is situated in an at least partially electrically driven vehicle.
